(19) United States
(12) Patent Application Publication
(10) Pub. No.: US 2002/0121203 A1
(43) Pub. Date: Sep. 5, 2002

(54) Paint applying ornamenting device

(76) Inventor: Howard M. Cohn, Cleveland, OH (US)

Correspondence Address: Howard M. Cohn, Patent & Trademark Attorney, 21625 Chagrin Blvd., Suite 220, Cleveland, OH, 44122, US

(21) Appl. No.: 10/071,791

(22) Filed: Feb. 7, 2002

Related U.S. Application Data
(63) Continuation of application No. 09/638,740, filed on Aug. 14, 2000.
(60) Provisional application No. 60/196,044, filed on Apr. 10, 2000.

(51) Int. Cl. B41K 1/42

(52) U.S. Cl. 101/333

(57) ABSTRACT

An ornamenting device is configured for applying marking fluid, preferably paint, upon a work surface to form an ornamental image. The device includes an applicator having a sponge-like, porous body with a transfer layer and a storage layer. The transfer layer has an imprinting surface configured to apply paint so as to cover a portion of the work surface to form the ornamental image and a plurality of first voids. The first voids are generally sized so as to substantially prevent any uncovered work surface sections remaining within the formed ornamental image. The storage layer is integrally formed with the transfer layer and has a plurality of second voids. Each of the second voids is sized generally larger than each of the first voids such that the storage layer has a substantially greater fluid absorbency than the transfer layer. A holder is configured for being held by a human hand and includes at least one prong insertable within the storage layer to releasably attach the applicator to the holder. Preferably, the holder includes a dome-shaped handle, a ring-shaped base connected with the handle and having an annular surface facing generally toward the applicator, and a plurality of the prongs connected with the base. The prongs are spaced circumferentially about and extend generally perpendicularly from the base annular surface. Further, each prong is preferably generally cylindrical with either a blunt or sharpened free end and may additionally include one or more projections.

### CROSS-REFERENCE TO RELATED APPLICATIONS

This is a continuation of U.S. patent application Ser. No. 09/638,740 filed Aug. 14, 2000, which claims the benefit of U.S. Provisional Patent Application No. 60/196,044 filed Apr. 10, 2000.

### BACKGROUND OF THE INVENTION

1. Field Of The Invention

The present invention relates to an improved printing block type of stenciling or imprinting device for applying decorative and ornamental designs upon a “work” surface, e.g., a wall, garment, etc., by transfer-printing a marking fluid to form various ornamental patterns, designs and/or images upon the surface. Although the device disclosed herein is referred to as an “ornamenting device”, the term ornamenting device is intended to encompass all types of stenciling or imprinting devices, particularly devices for applying a pattern of a marking fluid (e.g., paint) onto a surface, such as onto a wall to simulate wallpaper.

2. Description Of The Prior Art

Devices for stenciling or imprinting a decorative and/or ornamental pattern upon a wall surface are known, such as those disclosed in the following U.S. Patents:

| | |
|---|---|
| Hampson | U.S. Pat. No. 1,908,237 |
| Harwood | U.S. Pat. No. 3,142,082 |
| Joseph | U.S. Pat. No. 3,180,260 |
| Lambros | U.S. Pat. No. 3,204,278 |
| Zacha et. al. | U.S. Pat. No. 3,785,000 |
| Hagen | U.S. Pat. No. 3,817,178 |
| Briggs | U.S. Pat. No. 3,843,992 |
| McGuire | U.S. Pat. No. 4,030,414 |
| Winston | U.S. Pat. No. 5,431,098 |

Certain of the above-listed references, for example Lambros, Zacha et al. and Hagen, teach an ornamenting device having an applicator formed as a sponge-like imprinting element. The imprinting element is formed of a sponge or foam material that includes numerous voids that absorb and release the marking fluid (e.g., paint, dye, etc.). With such ornamenting devices, the imprinting element typically includes an integral imprinting face formed out of the sponge/foam material.

To ensure that a relatively smooth pattern of marking fluid is applied to a surface such as a wall, the voids at the imprinting face of the imprinting element should be relatively small, because large voids yield voids in the pattern on the wall. However, for maximum fluid absorption or “take-up” into the sponge-like member, the voids should be relatively large. The void size of the imprinting elements of known ornamenting devices are generally selected to be a compromise between the two considerations.

The devices disclosed in the above-listed patents all include an imprinting element that is fixedly or non-removably attached to a holder element. Certain devices are known that have a sponge-like imprinting element that is removably attached from a holder element, such as by means of an annular flange on one element (e.g., the holder element) that interlocks with an annular grove on the other element (i.e., the imprinting element). However, the removable or releasable attachment means of known devices have been found to have the potential to tear or otherwise damage the sponge material of the imprinting element.

Two examples of prior art patents which disclose a sponge-like imprinting element that are removably attached to a holder element are U.S. Pat. Nos. 5,832,832 and 5,857,411 to Carsel.

### OBJECTS OF THE PRESENT INVENTION

In view of the foregoing, it is an object of the present invention to provide an ornamenting device with an imprinting element having both minimal void size at the imprinting face and a substantial fluid absorbency.

A further object of the present invention to provide an ornamenting device constructed so that the imprinting element may be easily removed for cleaning and storage.

It another object of the present invention to provide an ornamenting device that has improved means for releasably or removably attaching the imprinting element to the holder element which minimize the potential for damaging the imprinting element during the removal and re-attachment thereof.

### SUMMARY OF THE INVENTION

In one aspect, the present invention is a device for applying a marking fluid upon a work surface to form an ornamental image. The device comprises a holder configured for being held by a human hand. An applicator is removably attached to the holder and has a sponge-like body with a porous interior configured to alternatively absorb and release the marking fluid. The body includes a transfer layer having an imprinting surface configured to apply the fluid to the work surface so as to cover a portion of the wall surface with the ornamental image. The transfer layer also has a plurality of first voids generally sized so as to substantially prevent any uncovered work surface sections remaining within the formed ornamental image. The body also includes a storage layer disposed generally between the transfer layer and the holder and having a plurality of second voids. Each of the second voids is generally sized substantially larger than each of the first voids such that the storage layer has a substantially greater fluid absorbency than the transfer layer.

In another aspect, the present invention is also a device for applying a marking fluid onto a work surface to form an ornamental image. The device comprises an applicator having a sponge-like body with a porous interior configured to alternatively absorb and release the marking fluid. The body has an imprinting surface configured to apply the fluid to the work surface so as form the ornamental image. A holder is configured for being held by a human hand and includes a prong insertable at least partially within the porous interior to releasably attach the applicator to the holder.

In yet another aspect, the present invention is a device for applying paint to a work surface to form an ornamental image. The device comprises an applicator having a sponge-like, porous body that includes a transfer layer and a storage layer. The transfer layer has an imprinting surface configured to apply paint to the work surface to form the ornamental image and a plurality of first voids. The storage layer is integrally formed with the transfer layer and has a plurality of second voids, each of the second voids being sized generally larger than each of the first voids. A holder configured for being held by a human hand includes at least one prong insertable within the storage layer to releasably attach the applicator to the holder.

### BRIEF DESCRIPTION OF THE DRAWINGS

FIG. 1 is a side elevational view of an ornamenting device constructed in accordance with the present invention, depicting an applicator body formed in one preferred construction and shown released from a holder;

FIG. 2 is top plan view of the ornamenting device;

FIG. 3 is a broken-away, side cross sectional view of the ornamenting device, depicting the applicator body formed in another preferred construction and shown releasably attached to the holder;

FIG. 4 is an enlarged, broken-away bottom plan view of the applicator taken at arrow 4 of FIG. 3, depicting a portion of an imprinting surface;

FIG. 5 is an enlarged, broken-away side cross sectional view of the ornamenting device, showing an attachment prong with projections;

FIG. 6 is an enlarged, broken-away side cross sectional view of the ornamenting device, depicting an alternative prong construction;

FIG. 7 is a broken-away, side cross sectional view of the holder showing the concave recesses;

FIG. 8 is view along line 8-8 of FIG. 7; and

FIG. 9 is a view along line 9-9 of FIG. 7.

### DETAILED DESCRIPTION OF THE PREFERRED EMBODIMENT

Referring now to the drawings in detail, wherein like numbers are used to indicate like elements throughout, there is shown in FIGS. 1-9 an inventive ornamenting device 10 for applying a marking fluid upon a work surface to form an ornamental image. The term “work surface” as used herein is intended to mean any surface to which an ornamental image is desired to be applied, for example walls, ceilings, strips or sheets of fabric, fixtures (e.g., pipes, a furnace, etc.), appliances (e.g., a refrigerator) and articles of furniture (e.g., cabinets, tables, vases, etc.). Further, the term “marking fluid” means any type of fluid or semi-fluid substance capable of being applied to a work surface to form an ornamental image, such as inks, dyes or paints. Although the preferred marking fluid for use in the present device 10 is paint, any other appropriate type of fluid may be alternatively be used with the device 10.

Basically, the ornamenting device 10 of the present invention comprises an applicator 12 for applying a marking fluid, preferably paint, to the wall surface and a holder 14 connected with the applicator 12 and configured for being held by a human hand. The applicator 12 has a sponge-like body 16 with a porous interior 17 configured to alternatively absorb and release the marking fluid and an imprinting surface 18 configured to apply the fluid to the work surface so as form the ornamental image. The holder 14 includes at least one and preferably a plurality of prongs 20 insertable at least partially within the porous interior 17 to releasably attach the applicator 12 to the holder 14.

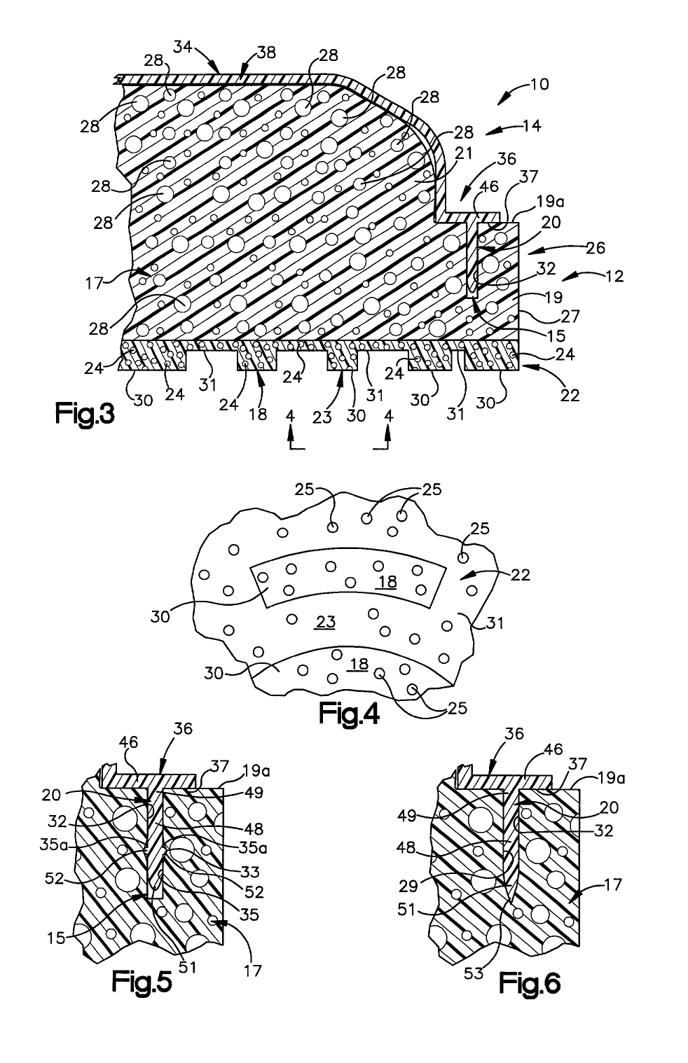

As best shown in FIGS. 1 and 3, the sponge-like body 16 preferably includes both a transfer layer 22 and a storage layer 26 located above the transfer layer 22, the storage layer 26 providing the major portion of the body 16. The transfer layer 22 has an exterior face 23 providing the imprinting surface 18 and has a plurality of first voids 24. The storage layer 26 is disposed generally between the transfer layer 22 and the holder 14 and has a plurality of second voids 28, each of the second voids 28 being sized generally larger than each of the first voids 24 for reasons discussed below. Each of the above-recited basic components/portions of the ornamenting device 10 is described in further detail below.

Referring particularly to FIG. 3, the sponge-like, porous body 16 of the applicator 12 is preferably formed of a resilient, open-celled, foam material. With such material, the body porous interior 17 is a fibrous, labyrinth-like material structure having numerous, generally spherical cells or voids 24, 28 interconnected by capillary-like pores or passages (not depicted) extending between the voids 24, 28. The voids 24, 28 and interconnecting pores enable a fluid(s) to be absorbed into the interior 17 of the body 16 and stored or retained therein. The stored fluid may be subsequently released from the porous interior 17 by application of a compressive force or pressure on the body 16, as discussed in further detail below. Suitable materials for fabricating the sponge-like body 16 include foam rubber, neoprene foam, polyethylene foam, urethane foam, cellulose acetate, polystyrene foam, vinyl foams, polyvinyl chloride, or any similar rubber or plastic material in a foamed, resilient condition.

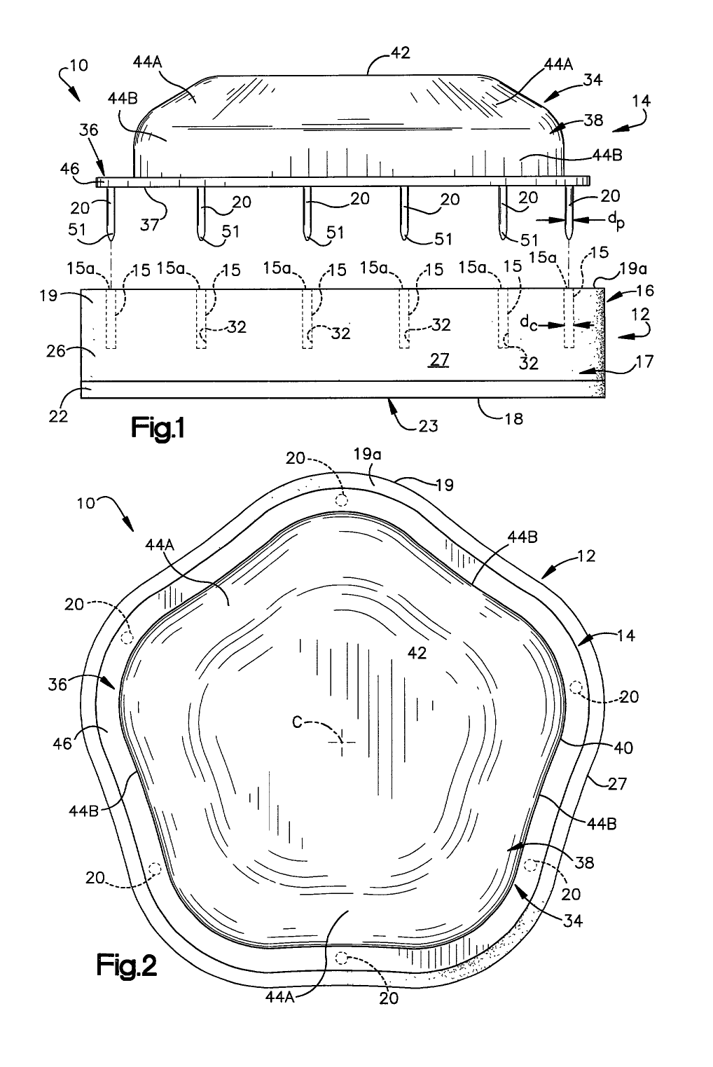

Referring to FIGS. 1-3, the sponge-like body 16 preferably includes a cylindrical portion 19 having a generally pentagon-shaped circumferential perimeter (see FIG. 2). In a first preferred construction shown in FIG. 1, the body 16 consists entirely of the cylindrical portion 19 and has an upper, generally flat exterior surface 19a that faces generally toward the holder 14. In a second preferred construction shown in FIG. 3, the sponge-like body 16 further includes a dome-shaped body portion 21 extending upwardly from the upper exterior surface 19a of the cylindrical portion 19. The two portions 19, 21 are either integrally formed or bonded together, such that the dome-shaped portion 21 provides part of the storage layer 26, as depicted.

The dome-shaped portion 21 is receivable within a mating opening in one preferred type of holder 14, as depicted in FIG. 3, to more securely attach the applicator 12 to the holder 14. Alternatively, the dome-shaped portion 21 may be used as a handle to manipulate the applicator 12 if the device 10 is desired to be used without the holder 14.

By having the dome-shaped portion 21, the fluid absorption capacity of the storage layer 26 (discussed below) is increased by the additional porous material, such that the second construction of the body 16 enables the device 10 to form a greater number of ornamental images before a re-filling with marking fluid is required as compared to the first body construction. On the other hand, the first construction (FIG. 1) of the body 16 is simpler to manufacture and requires less material, resulting in lower fabrication cost compared with the second body construction (FIG. 3). Also, the first body construction is lighter than the second construction, particularly when saturated with marking fluid, which makes an ornamental device 10 having the first type of sponge-like body 16 easier to handle.

Referring particularly to FIG. 1, with either construction, the sponge-like body 16 may further include one or more pre-formed channels 15 extending from the upper, exterior surface 19a and into the material of the porous interior 17. Each channel 15 is a preferably a closed-end or “blind” hole bounded by interior wall surfaces 32 of the body interior 17, such wall surfaces 32 being provided by surrounding portions of the sponge-like material of the body 16. The pre-formed channels 15 facilitate insertion of the one or more prongs 20 into the sponge-like body 16 and are “pre-formed” as opposed to being formed by piercing of the prongs 20, as discussed in further detail below.

The dome-shaped portion 21 of the second preferred body construction and the pentagon-shaped perimeter of the cylinder portion 19 in both preferred body constructions are incorporated into the structure of the body 16 due to the preferred structure of the holder 14, as depicted in the drawings and described below. However, it is within the scope of the present invention to form the sponge-like body 16 with any other appropriate shape or configuration. For example, the body 16 may be formed with the cylindrical portion 21 having a circular perimeter, as a generally rectangular block, as a hemisphere, etc., particularly when the applicator 12 is used with a holder 14 constructed other than as depicted in the drawing figures.

Referring to FIGS. 3 and 4, the imprinting surface 18 of the applicator 12 is provided by at least one and preferably plurality of raised sections 30 of the exterior face 23 of the transfer layer 22. The one or more raised sections 30 form a two-dimensional pattern of the desired ornamental image and are shaped by relieving or removing the remaining portions of the exterior face 23 to form one or more recessed sections 31. More specifically, the imprinting surface 18 is provided either by molding the exterior face 23 to have the raised and recessed sections 30, 31, respectively, with a desired shape/pattern or by cutting-away, etching, ablating or otherwise removing material from the face 23 so as to form the recessed sections 31 (and thereby also the raised sections 30).

As described above, the imprinting surface 18 is configured to apply marking fluid stored within or flowing through the transfer layer 22 to a work surface so as to cover a portion of the work surface with the ornamental image. In other words, when a user presses the imprinting surface 18 against a particular work surface, marking fluid is transferred through pores in the transfer layer 22 to the work surface. The first voids 24 of the transfer layer 22 are generally sized so as to substantially prevent any uncovered sections of the work surface within an ornamental image formed by the imprinting surface 18, as discussed below.

Specifically, the imprinting surface 18, as with the imprinting surface of any sponge-like printing element, includes numerous generally hemispherical cavities 25, as shown in FIG. 4. These cavities 25 result from the partial formation of first voids 24 at the exterior face 23 of the transfer layer 22. When the applicator 12 is used to form an ornamental image, marking fluid tends to flow around these hemispherical cavities 25 and through sections of the imprinting surface 18 surrounding each such cavity 25. By flowing in this manner, circular gaps appear in the ornamental image when the marking fluid is applied to the work surface. If these circular gaps are too large, marking fluid from adjacent portions of the applied image may not flow or “spread” sufficiently to fill-in the gaps, leaving uncovered sections of the work surface within the formed ornamental image. Therefore, to substantially prevent the occurrence of uncovered sections of the work surface within a formed/applied ornamental image, the transfer layer 22 is formed such that the first voids 24 (and thus also the surface cavities 25) are sufficiently small to eliminate, or at least minimize the size of, any circular gaps in the image.

However, the absorbency of sponge or foam material is generally greater when the material contains relatively large-sized voids. Large voids enable the material to not only absorb and retain a greater volume of a fluid, but also absorb a particular quantity of fluid at a generally faster rate, as compared to material having relatively small-sized voids. As such, the sponge-like body 16 of the applicator 12 would have generally unsatisfactory absorbency if the body 16 were formed having only the first voids 24.

Therefore, the preferred construction of the sponge-like body 16 has both the transfer layer 22 and a storage layer 26 with a plurality of second voids 28 that are each sized generally larger than each of the first voids 24, as discussed above. By having the large-sized second voids 28, the storage layer 26 has a substantially greater fluid absorbency than the transfer layer 22, both in terms of the maximum volume of fluid retainable therein and the rate of fluid absorption.

Preferably, as best shown in FIG. 1, the storage layer 26 has an exterior perimetrical or circumferential side surface 27 that is generally exposed as opposed to being enclosed (e.g., within the interior of the holder 14). With the exposed side surface 27, the storage layer 26 is capable of directly absorbing fluid from a fluid supply, for example a bucket of paint (not shown), through the exterior surface 27, rather than requiring fluid to be absorbed into the storage layer 26 through the less absorbent transfer layer 22.

In addition to virtually eliminating uncovered sections within an ornamental image, the small-sized first voids 24 in the transfer layer 22 causes marking fluid to flow through the layer 22 at a lesser or slower rate than the fluid flows through the storage layer 26. As such, marking fluid flowing through the imprinting surface 18 is applied to a work surface in relatively slow, controlled manner. The “controlled” application of the marking fluid reduces the likelihood of the ornamental image being formed with an excessive amount of the fluid, which may run-off and distort or otherwise mar the appearance of the ornamental image.

It is appropriate to note here that the terms “first voids” and “second voids” as used herein are not intended to indicate any specific void size or indicate that any group of voids has a generally uniform size. Rather, the two terms are used to reflect the relative difference between the average size of the voids (voids 24) in the transfer layer 22 and the voids (voids 28) in the storage layer 26. The actual average void size of either group of voids 24, 28 depends on the particular material(s) selected for the two layers 22, 26 and it is only important that the voids 28 in the storage layer 26 are, in general, substantially larger than the voids 24 in the transfer layer 22, for the reasons discussed above.

Further, there may be substantial size variations among the actual voids in either or both of the group of first voids 24 and the group of second voids 28, as depicted in FIG. 3. In addition, although it is preferred that there is a substantial size difference between the first and second voids 24, 28, respectively, the actual relative size difference may be greater or lesser than as depicted (FIG. 3), depending on such factors as the type(s) of material used to fabricate the body 16, the particular type of marking fluid intended to be used in the device 10, etc. Furthermore, the storage layer 26 may include some voids that are about the size of the first voids 24, as long as the storage layer 26 has a sufficient percentage of the second voids 28 to have satisfactory absorbency.

Referring to FIGS. 1-3, the transfer layer 22 and the storage layer 26 are preferably either integrally formed with each other or bonded together such that the sponge-like body 16 is of one-piece construction. Preferably, the sponge-like body 16 is constructed with the storage layer 26 being substantially thicker than the transfer layer 22. As such, the voids in the body interior 17 are primarily the second voids 28 so that the body 16 has a relatively substantial fluid absorbency. Most preferably, the transfer layer 22 has an overall thickness that is about twice the height of the raised section(s) 30 of the exterior face 23, such that the transfer layer 22 has sufficient structural integrity but contributes only a relatively small portion of the total material of the sponge-like body 16.

The two-layer, one-piece structure of the sponge-like body 16 may be formed by a variety of techniques known in the sponge-forming art, such that a detailed recitation of specific manufacturing/fabricating techniques is beyond the scope of the present disclosure. However, as certain information concerning the formation of the applicator body 16 may be helpful to understanding the present invention, these points of information are discussed as follows.

The void size of any particular piece or “batch” of a foam material is dictated by a variety of parameters. Different types of raw materials and/or chemical foaming agents will produce finished foam materials that have different void sizes. Also, differences in particle size of two powders formed of the same resin material will produce foam materials having different void sizes; the larger resin particles producing larger voids, and vice-versa. Further, certain process parameters can be controlled/varied to effect void size in the foam material produced thereby, such parameters including heating temperature, heating time, compression pressure applied to raw material/compound in a mold, mechanical foaming action (e.g., absorption pressure of an inert gas), etc.

Preferably, the sponge-like body 16 is produced using one of the two following methods. In the first method, the transfer layer 22 is first formed by pouring or otherwise depositing a first quantity of raw material compound, such as a resin powder with or without a chemical foaming agent, in a mold (not shown) having an appropriate shape. Heat and pressure, and also mechanical foaming action if no chemical foaming agent is present, is then applied to the raw compound in the mold so as to form a transfer layer piece (not shown) with first voids 24 of about a desired size or below a maximum desired size. Next, a second quantity of raw compound for the storage layer 26 is poured into the mold to cover the formed transfer layer piece and then appropriate amounts of heat, compressive pressure, etc. are applied to the raw compound to form the foam material of the storage layer 26 with voids of about the desired size for the second voids 28. The formed storage layer 26 becomes bonded to the transfer layer piece as the second quantity of raw compound transforms into finished foam material, thereby producing the two-layer, sponge-like body 16.

In the second method, a block or strip of a finished sponge-like material having voids sized about the desired size of the second voids 28 is cut to a desired thickness and shape to form a storage layer piece (not shown). Next, a quantity of raw material for the transfer layer 22 is poured into an appropriately shaped mold and the storage layer piece is placed in the mold to rest on the upper surface of the transfer layer raw material. Appropriate amounts of heat, compressive pressure, etc., are applied to the raw material in the mold to form a foam material with voids sized about the desired size of the first voids 24, thereby producing the transfer layer 22, which becomes bonded to the storage layer piece to produce the sponge-like body 16.

Although two methods for producing the sponge-like body 16 are generally described above, it is within the scope of the present invention to form the applicator body 16 using any other appropriate technique or manufacturing process. The present invention is not directed to any particular method of producing the sponge-like body 16, such that any appropriate manufacturing or fabrication process may be used.

Referring to FIGS. 1-9, the holder 14 preferably comprises a handle 34, a base 36 connected with the handle 34 and one or more of the prongs 20 attached to the base 36. The base 36 has a lower surface 37 facing generally toward the applicator 12 and the prong(s) 20 each extend generally perpendicularly from the base surface 37 in a direction generally toward the applicator 12. With the preferred plurality of the prongs 20, the several prongs 20 are spaced apart on the base surface 37 to increase the overall area of engagement with the sponge-like body 16, as shown in FIGS. 1 and 2, for reasons discussed below.

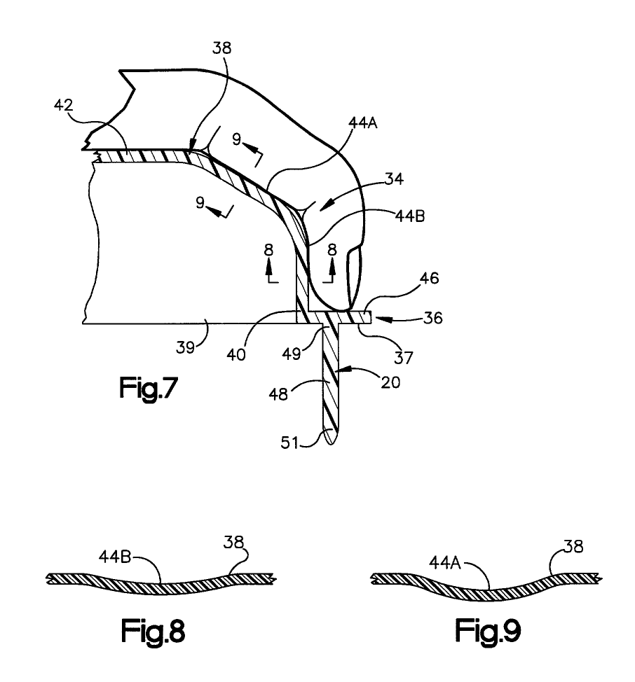

Referring now to FIGS. 1-3 and 7-9, the handle 34 is preferably formed as a generally dome-shaped shell half 38 having an open end 39 and a generally pentagon-shaped edge 40 surrounding the open end 39. The shell half 38 preferably includes a central hub section 42 and a plurality of upper and lower shallow, concave recesses 44A, 44B, respectively, spaced circumferentially about the central hub section 42. The central hub section 42 is configured to be disposed against the palm of a user's hand and each of the recesses 44A, 44B is configured to receive a portion of a digit (i.e., thumb or finger) of the user's hand, as best shown in FIGS. 7-9. The preferred handle structure enables the user to apply pressure to the applicator 12, as discussed below, by pressing against the recesses 44A, 44B with the user's digits and/or by pressing against the central hub 42 with the user's palm.

However, the handle 34 may alternatively be constructed in any other configuration that enables the holder 14 to be held by a human hand (i.e., of the user) and that is connectable with the base 36 or other holder element/portion to which the prong(s) 20 are connected. For example, the handle 34 may constructed as a rounded knob, as a generally vertical post or as a “U”-shaped or “C”-shaped bar (none shown). The present invention encompasses these and all other appropriate configurations for the handle 34.

Referring to FIGS. 1-3, the base 36 is preferably generally ring-shaped, and more specifically, is preferably constructed as a generally flat, pentagon-shaped ring 46 (see FIG. 2) connected to the edge 40 of the shell half 38. With a ring-shaped base 36, the base surface 37 is generally annular and is located a significant radial distance from the geometric center C (FIG. 2) of the holder 14. As such, the prongs 20 connected with the base 36 are spaced circumferentially about the annular base surface 37 so as to be located a substantial distance apart and arranged in a generally circular pattern (see FIG. 2). The prongs 20 thus engage with the sponge-like body 16 over a sufficiently wide area of the body 16 to help prevent the applicator 12 from becoming detached from the holder 14 during use of the ornamenting device 10.

Although a ring-shaped base 36 is preferred, the holder base 36 may alternatively be constructed in any other appropriate configuration. For example, the base 36 may be formed as a circular disk, a shell/shell portion, a block of any appropriate shape, etc. (none shown). The present invention encompasses all configurations of the holder base 36 to which the handle 34 and the prongs 20 may be mounted or otherwise connected. In addition, the holder 14 may even be constructed without any base 36, in which case the one or more prongs 20 are attached directly to the handle 34 (not shown).

Referring to FIGS. 1-3, 5 and 6, each prong 20 is preferably configured as an elongated projection having a first end 49 connected with the base 36, a second, free end 51 and a shaft-like body 48 extending between the two ends 49 and 51. The shaft-like body 48 is preferably generally cylindrical with a substantially solid cross-section of any desired shape, such as circular, square, triangular, pentagonal, etc. The shaft-like body 48 preferably has a sufficient thickness to be generally similar to a peg or stake, as depicted, but may also be relatively thin so as to be generally formed as a needle or pin or even relatively thick in the nature of a knob. Further, the shaft-like body 48 of each prong 20 preferably has a generally uniform diameter or thickness along the length of the body 48. Furthermore, the plurality of prongs 20 preferably have bodies 48 that are all of a generally uniform length as depicted in FIG. 1, but may alternatively be formed of different or various lengths if desired (not depicted).

Alternatively, the shaft-like body 48 may be tubular rather than cylindrical, with any appropriate “hollow” cross-sectional shape (e.g., circular, triangular, etc.). As yet another alternative, the shaft-like body 48 may be generally blade-like (not shown) rather than cylindrical, with either a generally flat or generally curved (e.g., arcuate) cross section. Furthermore, the shaft-like body 48 may have a tapering diameter (not shown) that increases along the length of the body 48 from the first end 49 to the second end 51, such that the second end “flares” outwardly. By having such a tapering diameter along the body 48, frictional forces between the prong 20 and interior wall surfaces 32 of the sponge-like body 16 are increased to more firmly secure the applicator 12 to the holder 14, as discussed below.

In one preferred construction shown in FIGS. 1, 3 and 5, each prong 20 has a generally “blunt” free end 51 that is rounded or tapered so as to facilitate insertion of the prong 20 into a pre-formed channel 15 of the sponge-like body 16. Referring to FIG. 6, in a second preferred construction, the free end 51 of each prong 20 has either a relatively sharp point 53 (as depicted) or an edge (not shown) that is configured to pierce into the porous interior 17 as the prong 20 is inserted into the sponge-like body 16. With the second prong construction, the holder 14 may be used with a sponge-like body 16 that does not include pre-formed channels 15. Instead, each prong 20 forms or cuts a channel 29 (FIG. 6) during an initial insertion of the prongs 20 into the body 16, as discussed in further detail below.

With either the generally “blunt” construction (FIGS. 1, 3 and 5) or the generally “sharp” construction (FIG. 6), the prongs 20 may each include one or more projections 52 that extend laterally from the shaft-like body 48, as shown in FIG. 5. The projections 52 may be formed as one or more individual bumps or knobs (as depicted), as a ring or ring segment (neither shown) or as any other desired configuration. The projection(s) 52 increase the frictional engagement of the prongs 20 with material surface sections of the body porous interior 17, as discussed in greater detail below.

Preferably, the prongs 20 are each integrally formed with holder 14 such that the first prong end 49 is integrally connected with the base 36. Alternatively, the prongs 20 may be provided by separate shaft-like members or pegs (not shown) that are either fixedly attached or removably mounted to the base 36. For example, the prongs 20 may each have a threaded first end 49 that engages a threaded hole (not shown) in the base 36. Further for example, the prongs 20 may each be formed as a peg (not shown) that is affixed to (e.g., bonded, welded, etc.) the base 36 or as a rivet-like member (not shown) force-fitted into a through hole (not shown) in the base 36. As yet another example, the first end 49 of each prong 20 may be formed with a clip portion (not shown) configured to grip or “clip” onto the base 36, such as to the outer circumferential edge of the ring 46, so as to be removably or releasably attached to the base 36.

Although the above-discussed structures and arrangements of the prongs 20 are preferred, it is within the scope of the present invention to form the holder 14 with any number of prongs 20 constructed in any appropriate manner. For example, the holder 14 may include a single knob-like or spike-like prong 20 (not shown) extending from the center of a solid block or disk providing the base 36. Further for example, the holder 14 may be include a base 36 configured as a bar and having only two prongs 20 of any desired configuration, each prong 20 being disposed proximal to a separate end of the bar (not shown). As yet another example, the prongs 20 may be arranged in a grid (as opposed to generally in a circular pattern). The present invention encompasses all appropriate structural configurations and arrangements of the prongs 20 that enable the applicator 12 to be attached to the holder 14 by insertion of the prong(s) into the applicator body 16.

Preferably, all of the elements/components of the holder 14, i.e., the handle 34, the base 36 and the prongs 20, are integrally formed with each other, such that the holder 14 is of one-piece construction. Most preferably, the preferred dome-shaped shell half 38, pentagon-shaped ring 46 and shaft-like prongs 20 are integrally formed of an injection molded polymeric material. However, it is within the scope of the present invention to form the holder 14 of any other appropriate material in any other appropriate manner. For example, the handle 34 and base 36 may each be separately formed of a stamped metal, such as aluminum, and the prongs 20 may be provided by aluminum rivets attached to the base 36. The present invention embraces these and all other appropriate constructions of the holder 14 that enables the ornamenting device 10 to function generally as described herein.

Prior to use, the ornamenting device 10 must be assembled by attaching the applicator 12 to the holder 14, if these components are not already so attached. With the preferred construction as described above, the prongs 20 are inserted into the porous interior 17 of the sponge-like body 16 such that each prong 20 frictionally engages with an interior surface portion or portions of the body 16 to releasably attach the applicator 12 to the holder 14.

More specifically, if the sponge-like body 16 is provided with the pre-formed channels 15, the holder 14 is positioned with respect to the applicator 12 such that each prong 20 is aligned with the open end 15a of a separate one of the channels 15. The prongs 20 are then inserted into the channels 15 such that each prong 20 frictionally engages with the channel interior wall surfaces 32, which releasably attaches the applicator 12 to the holder 14. Referring to FIG. 1, the channels 15 are preferably formed with a diameter dc that is sufficiently smaller than the diameter dₚ of each prong 20 such that the prongs 20 are “force-fitted” into the channels 15.

If the sponge-like body 16 does not include pre-formed channels 15, the prongs 20, which in this case are preferably of the second, sharp construction (FIG. 6), are pressed against the upper surface 19a of the sponge-like body 16 to pierce through the body material and embed within the porous interior 17. More specifically, when the prongs 20 are first inserted into the body interior 17, the sharp leading edge or point 53 of each prong 20 cuts into and through the body material to form a cut channel 29 (FIG. 6). The prongs 20 each frictionally engage with interior wall surfaces 32 the body 16, provided by cut portions of the body material, to releasably attach the applicator 12 to the holder 14. After initial insertion of the prongs 20, the cut channels 29 may be utilized, in the same manner as the pre-formed channels 15, when re-attaching the applicator 12 to the holder 14.

Referring to FIG. 5, with prongs 20 that include the projections 52, the projections 52 cause adjacent sections 33 of the interior wall surfaces 32 to deflect outwardly with respect to the prong 20 to a greater extent than remaining sections 35 of the wall surfaces 32, which locally increases compression of the body material to thereby increase the amount of friction on the prongs 20 at the projections 52. Further, the projections 52 engage against wall surface sections 35a located above the projections 52 in a manner generally similar to a bolt head, such that these interior surface sections 35a help prevent disengagement of the prongs 20 from the body interior 17.

Although it is preferred to releasably attach the applicator 12 to the holder 14, the ornamenting device 10 may be alternatively assembled such that the applicator 12 is fixedly or non-removably attached to the holder 14. For example, an adhesive substance (e.g., glue) may be inserted within the body channels 15, 29 so as to bond the prongs 20 within the body interior 17.

After the applicator 12 is attached to the holder 14, the applicator 12 is provided with a quantity of the marking fluid, preferably paint as discussed above. Although paint is the preferred marking fluid to be applied by the ornamenting device 10, any other appropriate marking fluid may alternatively be used, such as for example ink, material dyes, colored water, etc., depending on the user's particular desired application or project. When paint is used as the marking fluid, the applicator 12 is preferably immersed in a supply of paint, such as a conventional paint bucket or tray, so that a quantity of the paint is absorbed into the sponge-like body 16, primarily through the side exterior surface 27 of the storage layer 26. Alternatively, paint or other marking fluid may be directly applied to the sponge-like body 16, for example by spraying or “squirting” the fluid onto the exterior surfaces 23, 27 of the body 16.

When the applicator 12 is supplied with a sufficient amount of the marking fluid, the user may then begin forming one or more ornamental images on a desired work surface, such as the walls and/or ceilings in a home or office, the sides of cabinet, a section of a garment, etc. The user first places or positions the imprinting surface 18 against a particular work surface and then applies pressure to the applicator 12 by pushing the handle 34, with palm and/or fingers, in a direction generally toward the work surface. The holder base 36, which is either in contact with or moves into contact with the upper surface 19a of the body 16, pushes against and partially compresses the sponge-like body 16 against the work surface, such that the body 16 is “sandwiched” between the holder 14 and the work surface. The compression or squeezing of the sponge-like body 16 causes the marking fluid contained within the porous interior 17 to flow from the storage layer 26 to the transfer layer 22 and/or to flow from the transfer layer 22, through the imprinting surface 18 and to the work surface.

Since only the raised sections 30 of transfer layer face 23 contact the work surface, the marking fluid flows from the applicator 12 only through the raised sections 30 and thus through the imprinting surface 18. As such, the marking fluid is applied to those sections of the work surface in contact with the raised sections 30, thereby creating the ornamental image as a duplicate or copy of the imprinting surface 18. Thereafter, the user may apply additional ornamental images to the particular work surface, or to other work surfaces, until the amount of marking fluid contained/retained within the sponge-like body 16 becomes depleted to the extent of being insufficient to form a clear ornamental image. Then, the user may add additional amounts of the marking fluid to the applicator 12, or may instead add another marking fluid thereto, such as paint of a different color, and form numerous ornamental images.

When the user is finished using the ornamenting device 10, the user pulls on the sponge-like body 16 in a direction generally away from the holder 14 so as to disengage the prongs 20 from the interior wall surfaces 32 of the body 16, thereby releasing the applicator 12. The particular applicator 12 may be cleaned and re-attached to the holder 14 or may be replaced with another applicator 12 having an imprinting surface 18 that is configured to form a different ornamental image.

Although the preferred embodiment of the invention disclosed herein is primarily disclosed as an ergonomic hand held device, many of the unique features taught, such as the prong(s) 20 for releasably attaching the sponge-like body 16 to the holder 14, may also be embodied within other similar devices, such as a stenciling device mounted within a machine for automatically forming numerous ornamental images, etc. Further, although the disclosed applicator 12 with a two-layer sponge-like body 16 and the holder 14 with one or more prongs 20 are preferably used in combination, the unique applicator 12 and the unique holder 14 may be used separately. For example, the applicator 12 may be used with any other type of holder (none shown) attached, releasably or fixedly, to the two-layer body 16 by any other appropriate means, such as by bonding with an adhesive or by using circumferential flange/groove interlock for attachment. Also for example, the holder 14 with the insertable prongs 20 may be used with a sponge-like body formed of only a single layer of material.

Thus it is evident that many alternatives, modifications, and variations of the present invention will be apparent to those skilled in the art in light of the foregoing teachings. Accordingly, the invention is intended to embrace all such alternatives, modifications and variations as fall within the spirit and scope of the appended claims.

We claim:

1. A device for applying a marking fluid upon a work surface to form an ornamental image, the device comprising:
a holder configured for being held by a human hand; and
an applicator removably attached to the holder and having a sponge-like body with a porous interior configured to alternatively absorb and release the marking fluid, the sponge-like body including:
a transfer layer having an imprinting surface, the imprinting surface being configured to apply the fluid to the work surface so as to cover a portion of the work surface with the ornamental image, and a plurality of first voids generally sized so as to substantially prevent any uncovered work surface sections remaining within the formed ornamental image; and
a storage layer disposed generally between the transfer layer and the holder and having a plurality of second voids, each of the second voids being generally sized substantially larger than each of the first voids such that the storage layer has a substantially greater fluid absorbency than the transfer layer.

2. The device as set forth in claim 1 wherein the applicator is at least partially immersible within a supply of the marking fluid and the storage layer has an exposed exterior surface such that the storage layer directly absorbs fluid from the fluid supply through the exterior surface when the applicator is disposed within the fluid supply.

3. The device as set forth in claim 1 wherein the transfer layer has an exterior face with at least one raised section providing the imprinting surface.

4. The device as set forth in claim 1 wherein the sponge-like body is formed of an open-celled, resinous foam material.

5. The device as set forth in claim 1 wherein the transfer layer and the storage layer are integrally formed with each other.

6. The device as set forth in claim 1 wherein the holder includes:
a handle formed as a generally dome-shaped shell half having a central hub section adapted for being disposed against a human palm and a plurality of concave recesses spaced circumferentially about the hub, each recess being configured for receiving a digit of a human hand, and a generally circular edge extending about an open end of the shell half; and
a generally ring-shaped base connected with the edge of the shell half and configured to releasably attach the applicator to the holder.

7. The device as set forth in claim 6 wherein the base has an annular base surface facing generally toward the applicator and the holder further includes a plurality of prongs spaced circumferentially about the base surface and insertable within the storage layer to releasably attach the applicator to the holder.

8. The device as set forth in claim 7 wherein the storage layer includes has an exterior surface facing generally toward the holder and a plurality of channels, each channel extending from the exterior surface and into the storage layer and being bounded by a separate interior surface, each prong being insertable into a separate one of the channels and frictionally engageable with the interior surface of the channel to releasably attach the applicator to the holder.

9. The device as set forth in claim 1 wherein the marking fluid is paint and the body is formed of a material suitable for absorbing and releasing paint.

10. A device for applying a marking fluid onto a work surface to form an ornamental image, the device comprising:
an applicator having a sponge-like body with a porous interior configured to alternatively absorb and release the marking fluid and an imprinting surface configured to apply the fluid to the work surface so as form the ornamental image; and
a holder configured for being held by a human hand and including a prong insertable at least partially within the porous interior to releasably attach the applicator to the holder.

11. The device as set forth in claim 10 wherein the holder further includes a handle, a base connected with the handle and having a surface facing generally toward the applicator, and a plurality of the prongs connected with the base, the prongs being spaced apart and extending generally perpendicularly from the base surface.

12. The device as set forth in claim 10 wherein the porous interior of the sponge-like body has an interior wall surface and the projection is frictionally engageable with the interior wall surface to releasably attach the applicator to the holder.

13. The device as set forth in claim 10 wherein the sponge-like body includes an exterior surface facing generally toward the holder and a pre-formed channel extending from the exterior surface and into the porous interior, the channel being bounded by an interior wall surface of the body porous interior, the prong being insertable within the channel and frictionally engageable with the channel interior surface to releasably attach the applicator to the holder.

14. The device as set forth in claim 10 wherein the prong includes one of a point and an edge configured to pierce into the porous interior as the prong is inserted into the sponge-like body.

15. The device as set forth in claim 10 wherein the prong includes an elongated shaft-like body and a projection extending laterally from the shaft-like body.

16. The device as set forth in claim 10 wherein the holder includes:
a handle formed as a generally dome-shaped shell half having a central hub section adapted for being disposed against a human palm and a plurality of concave recesses spaced circumferentially about the hub, each recess being configured for receiving a digit of a human hand, and a generally circular edge extending about an open end of the shell half;
a ring-shaped base connected with the edge of the shell half and having an annular surface facing generally toward the applicator; and
a plurality of the prongs connected with the base, the prongs being spaced circumferentially about and extending generally perpendicularly from the base annular surface.

17. The device as set forth in claim 10 wherein the sponge-like body is formed of an open-celled, resinous foam material.

18. The device as set forth in claim 10 wherein the marking fluid is paint and the sponge-like body is formed of a material suitable for absorbing and releasing paint.

19. A device for applying paint upon a work surface to form an ornamental image, the device comprising:
an applicator having a sponge-like, porous body including:
a transfer layer having an imprinting surface, the imprinting surface being configured to apply paint to the work surface to form the ornamental image, and a plurality of first voids; and
a storage layer integrally formed with the transfer layer and having a plurality of second voids, each of the second voids being sized generally larger than each of the first voids; and
a holder configured for being held by a human hand and including at least one prong insertable within the storage layer to releasably attach the applicator to the holder.
